(19) United States
(12) Patent Application Publication
(10) Pub. No.: US 2025/0282989 A1
(43) Pub. Date: Sep. 11, 2025

(54) SCALE INHIBITORS AND RELATED METHODS

(71) Applicant: LFS CHEMISTRY INCORPORATED, Cresson, TX (US)

(72) Inventors: Ramanathan S. LALGUDI, Westerville, OH (US); Neil HAYES, Houston, TX (US); Darin OSWALD, Edmonton (CA); Marcus JONES, Cresson, TX (US); James HOLMES, Cresson, TX (US)

(73) Assignee: LFS CHEMISTRY INCORPORATED, Cresson, TX (US)

(21) Appl. No.: 18/861,515

(22) PCT Filed: May 10, 2023
(86) PCT No.: PCT/US2023/021732

§ 371 Date: Oct. 29, 2024

Related U.S. Application Data
(63) Continuation of application No. PCT/US2022/037694, filed on Jul. 20, 2022.
(60) Provisional application No. 63/341,550, filed on May 13, 2022.
(60) Provisional application No. 63/386,746, filed on Dec. 9, 2022.

(51) Int. Cl. C09K 8/536; C07F 9/38

(52) U.S. Cl. CPC C09K 8/536; C07F 9/3856; C09K 2208/32

(57) ABSTRACT

[bis[2-[bis(phosphonomethyl)amino]ethyl]amino]methylphosphonic acid metal salt may be used as a scale inhibitor in wellbore applications. Said scale inhibitors and related methods may incorporate controlled release characteristics. For example, a scale inhibition method may include introducing [bis[2-[bis(phosphonomethyl)amino]ethyl]amino]methylphosphonic acid metal salt (e.g., as a particulate thereof or adsorbed in a porous particle) into a wellbore penetrating a subterranean formation; heating the Compound I to a temperature of 150° F. or greater while in the wellbore and/or in the subterranean formation so as to release the Compound I; and inhibiting scale in a portion of the wellbore and/or the subterranean formation.

### FIELD

The present disclosure relates to scale inhibitors and related methods.

### BACKGROUND

Scale refers to solid deposits that accumulate and grow on surfaces that adversely affect the flow of fluid over that surface. Said surfaces may be part of a pipeline, pipe, valve, pump, or the like. Scale may build up to a point of blocking fluid flow through a flow path.

Common compositions of scale found in hydrocarbon production environments may include carbonates and sulfate (e.g., iron sulfite, barium sulfate, and strontium sulfate). Scale inhibition is a technique that aims to reduce the formation and mitigate the growth of scale deposits. Scale inhibition techniques often include adding chemicals to fluids pumped into a wellbore that reduce the formation and mitigate the growth of scale deposits.

### SUMMARY

The present disclosure relates to scale inhibitors and related methods.

An example scale inhibitor is Compound I

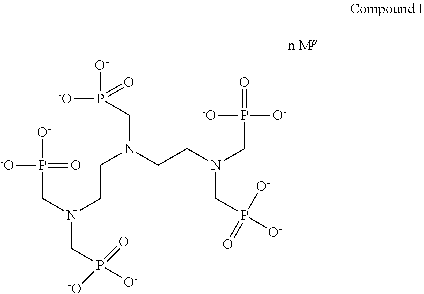

where M^{p+} is a metal cation having a p+ charge with p being an integer of 2, 3, or 4, and where n is an integer from 1 to 5.

Said scale inhibitor may be implemented, for example, as particles of Compound I or particles comprising Compound I (e.g., particles comprising porous particles and Compound I). In either implementation, controlled release of Compound I at a desired location may be triggered, for example, by temperature and/or exposure to specific chemicals.

Methods of the present disclosure may include: introducing a wellbore fluid into a wellbore penetrating a subterranean formation, wherein the wellbore fluid comprises Compound I.

Methods of the present disclosure may include: introducing Compound I into a wellbore penetrating a subterranean formation; and inhibiting scale in a portion of the wellbore and/or the subterranean formation.

Methods of the present disclosure may include: introducing Compound I into a wellbore penetrating a subterranean formation; heating the Compound I to a temperature of 150° F. or greater while in the wellbore and/or in the subterranean formation so as to release the Compound I from the particulates; and inhibiting scale in a portion of the wellbore and/or the subterranean formation.

### BRIEF DESCRIPTION OF THE DRAWINGS

The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1 is a diagram illustrating a nonlimiting example of a controlled release particle of the present disclosure.

FIG. 2 is a diagram of a proposed mechanism by which the controlled release particles behave.

FIG. 3A illustrates a nonlimiting example reaction scheme for synthesizing a multi-urethane backbone.

FIGS. 3B and 3C illustrate nonlimiting example reaction schemes for producing Compounds I and II, respectively, from the multi-urethane backbone of FIG. 3A.

### DETAILED DESCRIPTION

The present disclosure relates to scale inhibitors and related methods. Said scale inhibitors and related methods may incorporate controlled release characteristics.

### [bis[2-[bis(phosphonomethyl)amino]ethyl]amino]methylphosphonic acid metal salt (Scale Inhibitor) and Related Controlled Release Particles

[bis[2-[bis(phosphonomethyl)amino]ethyl]amino]methylphosphonic acid metal salt has a formula according to Compound I. A specific example is pentazinc; [bis[2-[bis(phosphonomethyl)amino]ethyl]amino]methylphosphonic acid, which has a formula according to Compound II. [Bis[2-[bis(phosphonomethyl)amino]ethyl]amino]methylphosphonic acid mono metal salt has a formula according to Compound III. [Bis[2-[bis(phosphonomethyl)amino]ethyl]amino]methylphosphonic acid di metal salt has a formula according to Compound IV. [Bis[2-[bis(phosphonomethyl)amino]ethyl]amino]methylphosphonic acid tri metal salt has a formula according to Compound V. Compounds III illustrate examples where n and p of Compound I allow for an O⁻ to be an OH.

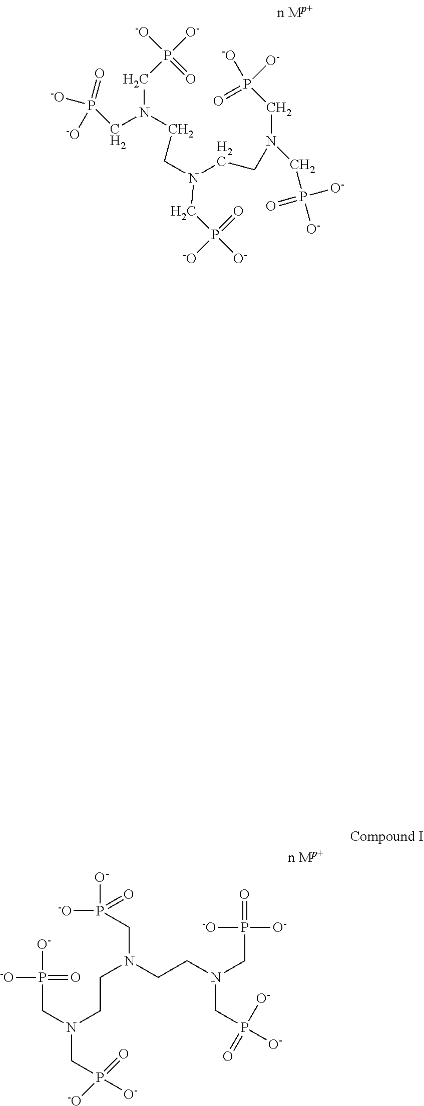

where M^{p+} is a metal cation having a p+ charge with p being an integer of 2, 3, or 4, where n is an integer from 1 to 5, and where one or more O⁻ is a OH depending n and p.

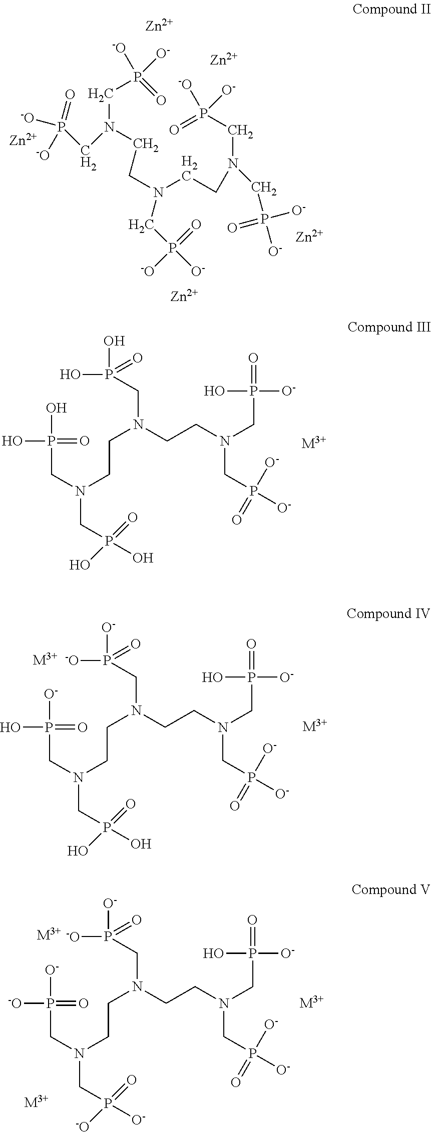

Compound I may be synthesized by mixing a metal salt with diethylenetriaminepenta(methylenephosphonic acid) to allow for ion exchange and precipitation of Compound I. Generally, the metal salt may be dissolved in water and combined with the diethylenetriaminepenta(methylenephosphonic acid). After Compound I precipitates, the precipitate may be separated from at least a portion of the liquid (e.g., via filtration, decanting, centrifuging, the like, and any combination thereof). If a solid form of Compound I is desired, the precipitate may be washed and dried.

The metal cation of the metal salt used in producing Compound I may be a M²⁺, a M³⁺ or an M⁴⁺ from Main Groups IIIA and IVA, the Transition Metals, the Lanthanide Series, or the Actinide Series. Examples may include, but are not limited to, zinc, nickel, cadmium, manganese, aluminum, scandium, gallium, lanthanum, iron, cobalt, boron, silicon, tin, bismuth, titanium, vanadium, chromium, tungsten, copper, and the like. The anion of the metal salt used in producing Compound I may include, but is not limited to, chlorides, fluorides, bromides, sulfates, nitrates, acetates, oxylates, citrates, hydroxides, and the like. Examples of specific metal salts may include, but are not limited to, zinc chloride, nickel chloride, cadmium chloride, manganese chloride, zinc fluoride, nickel fluoride, cadmium fluoride, manganese fluoride, zinc bromide, nickel bromide, cadmium bromide, manganese bromide, zinc sulfate, nickel sulfate, cadmium sulfate, manganese sulfate, zinc nitrate, nickel nitrate, cadmium nitrate, manganese nitrate, zinc acetate, nickel acetate, cadmium acetate, manganese acetate, zinc oxylate, nickel oxylate, cadmium oxylate, manganese oxylate, zinc citrate, nickel citrate, cadmium citrate, manganese citrate, zinc hydroxide, nickel hydroxide, cadmium hydroxide, manganese hydroxide, aluminum chloride, boron chloride, scandium chloride, chromium chloride, iron chloride, gallium chloride, lanthanum chloride, aluminum fluoride, boron fluoride, scandium fluoride, chromium fluoride, iron fluoride, gallium fluoride, lanthanum fluoride, aluminum bromide, boron bromide, scandium bromide, chromium bromide, iron bromide, gallium bromide, lanthanum bromide, aluminum sulfate, boron sulfate, scandium sulfate, chromium sulfate, iron sulfate, gallium sulfate, lanthanum sulfate, aluminum nitrate, boron nitrate, scandium nitrate, chromium nitrate, iron nitrate, gallium nitrate, lanthanum nitrate, aluminum acetate, boron acetate, scandium acetate, chromium acetate, iron acetate, gallium acetate, lanthanum acetate, aluminum oxylate, boron oxylate, scandium oxylate, chromium oxylate, iron oxylate, gallium oxylate, lanthanum oxylate, aluminum citrate, boron citrate, scandium citrate, chromium citrate, iron citrate, gallium citrate, lanthanum citrate, aluminum hydroxide, boron hydroxide, scandium hydroxide, chromium hydroxide, iron hydroxide, gallium hydroxide, lanthanum hydroxide, and the like. The metal salt may have a number of waters of hydration ranging from zero to thirty. More than one metal salt may be used when producing Compound I. When using two or more metal salts, said salts may vary by cation, anion, or both.

Dissolution of the metal salt and the mixing may, independently, be at room temperature or at an elevated temperature (e.g., about 25° C. to about 70° C., or about 25° C. to about 50° C., or about 35° C. to about 60° C., about 45° C. to about 70° C.).

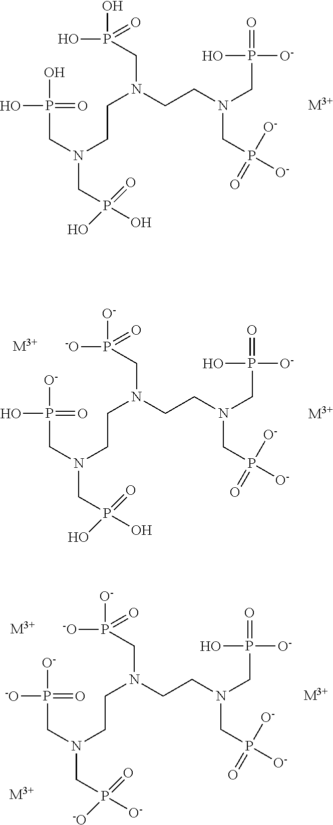

The molar ratio of [bis[2-[bis(phosphonomethyl)amino]ethyl]amino]methylphosphonic acid to M^{p+} in a mixture used to produce Compound I may range from 0.5:1 to 1:10 (or 0.5:1 to 1:5, or 1:1 to 1:3, or 0.5:1 to 1:1.5, or 1:1.5 to 1:2.5, or 1:2.5 to 1:3.5, or 1:3 to 1:10). For M³⁺, molar ratios at or close to 1:1 (e.g., 0.5:1 to 1:1.5) may provide primarily for Compound III. For M³⁺, molar ratios at or close to 1:2 (e.g., 1:1.5 to 1:2.5) may provide primarily for Compound IV. For M³⁺, molar ratios at or close to or in significant excess of 1:3 (e.g., 1:2.5 to 1:3.5 or 1:2.5 to 1:4) or at or in significant excess of 1:3 (e.g., 1:3 to 1:10) may provide primarily for Compound V. One skilled in the art will recognize the other molar ratios suitable when using M²⁺ and M⁴⁺ to get a desired number of metal ions per [bis[2-[bis(phosphonomethyl)amino]ethyl]amino]methylphosphonic acid.

### Scale Inhibitors and Related Methods

Compound I (a single Compound I or a plurality of Compound I with different metal cations) may be useful as a scale inhibitor and/or a corrosion inhibitor in downhole applications. Accordingly, methods may include introducing Compound I (a single Compound I or a plurality of Compound I with different metal cations) into a wellbore penetrating a subterranean formation; and mitigating scale formation on and/or corrosion of downhole wellbore tools (e.g., tubulars) present in the wellbore. Compound I may be introduced as an additive in a wellbore fluid (e.g., an aqueous-based wellbore fluid, an emulsion wellbore fluid with a continuous water phase, or an invert emulsion wellbore fluid with a discontinuous (or dispersed) water phase) where Compound I (cumulatively when more than one Compound I is included) may be present at about 0.001 wt % to about 20 wt % (or about 0.001 wt % to about 1 wt %, or about 0.01 wt % to about 2 wt %, or about 0.1 wt % to about 5 wt %, or about 2 wt % to about 10 wt %, or about 5 wt % to about 15 wt %, or about 10 wt % to about 20 wt %) of the water in the wellbore fluid.

Compound I may be in particulate form when introduced into the wellbore. Said particulate form may be particles (e.g., precipitated particles) of Compound I or porous particles with Compound I absorbed in the pores thereof. In either instance, the particles (either comprising or formed of Compound I) may have controlled release properties, which may be triggered by temperature and/or exposure to specific chemicals (e.g., acids, CO₂, H₂S, and the like).

Particles of Compound I may consist of Compound I. Said particles may be produced by precipitating Compound I, which may be used as precipitated, after cleaning, or after further milling (or grinding) to achieve a desired particle size (e.g., about 10 μm to about 750 μm). As illustrated in the Examples, said particles consisting of Compound I may respond to temperature and have controlled release (or controlled dissolution) properties.

In a nonlimiting example method to create a controlled release particle comprising Compound I, an aqueous solution of the active compound (Compound I) can be mixed using any industrial mixer with a specified metal salt solution. The slurry formed may then be dried (e.g., at 105° C. for 3 hours or longer) to reduce the moisture content to less than 8 wt %. The dried product can be pulverized to produce free flowing particles with particle size under 40 mesh (about 400 μm).

In another nonlimiting example method to create a controlled release particle comprising Compound I, an aqueous solution of the active chemical (Compound I) can mixed using any industrial mixer with a specified metal salt solution. To the slurry formed, water can be added and filtered using a vacuum filtration or any other industrial filtration systems. The wet cake can be dried (e.g., at 105° C. for 3 hours or more) to a moisture content less than 8 wt %. The dried product can be pulverized to produce free flowing particles with particle size under 40 mesh (about 400 μm).

Compound I may be a portion (or component) of a controlled release particle that is introduced into the wellbore. The controlled release particle may be a porous particle with Compound I absorbed in the pores thereof. The controlled release particle may be a controlled release particle with a stimuli-responsive coating (described in detail below). Accordingly, methods may include introducing the a controlled release particle comprising Compound I into a wellbore penetrating a subterranean formation; allowing Compound I to release from the controlled release particle while in the wellbore; and mitigating scale formation on and/or corrosion of downhole wellbore tools (e.g., tubulars) present in the wellbore.

To create a controlled release particle comprising Compound I and a porous particle, Compound I and the porous particle may be mixed (or kept in contact) for a sufficient time to absorb Compound I into the pores of the porous particle. Such sufficient time may depend on the pore size of the porous particle and the relative concentrations of Compound I and the porous particle. Water is preferably present during the mixing (or contacting) step. After mixing, the product may be washed and optionally dried before use. Alternatively, a majority (e.g., at least 50 wt %, or at least 75 wt %) of the liquid portion of the product may be removed (e.g., via filtration, decanting, centrifuging, the like, and any combination thereof) and the product with liquid still present may be blended with other components (e.g., nonporous particles, surfactants, polymers, weighting agents, and the like) to produce a wellbore fluid or an additive for said wellbore fluid. The wellbore fluid may be aqueous-based, oil-based, an emulsion, or an invert emulsion where for the emulsion and invert emulsion the location of the controlled release particle may depend on the structure and/or surface chemistry of the controlled release particle.

In another nonlimiting example method, an aqueous solution of the active chemical (Compound I) can be sprayed onto a porous particle in the ratio 65% of active chemical and 35% of porous particle and form a solid intermediate S1. Separately, a specified metal salt solution can be sprayed onto a porous particle in the ratio 65% of active chemical and 35% of porous particle to produce a solid intermediate S2. The solid intermediate S1 and S2 in the weight ratio of 1:1 when added to water create a controlled release particle comprising Compound I and the porous particle.

During the mixing (or contacting) step, the weight ratio of Compound I to the porous particle may be about 0.1:1 to about 2:1 (or about 0.1:1 to about 1:1, or about 0.5:1 to about 1.5:1, or about 1:1 to about 2:1). After absorption, the weight ratio of Compound I to the porous particle (measured on a dried sample) may be about 0.01:1 to about 1:1 (or about 0.01:1 to about 0.5:1, or about 0.1:1 to about 1:1, or about 0.5:1 to about 1:1).

Controlled release particles comprising Compound I may be present at about 0.001 wt % to about 10 wt % (or about 0.001 wt % to about 1 wt %, or about 0.01 wt % to about 2 wt %, or about 0.1 wt % to about 5 wt %, or about 2 wt % to about 10 wt %) of the liquid in the wellbore fluid.

Porous particles of the controlled release particles may include, but are not limited to, porous amorphous silica, cyclodextrin, carbon nanotubes, metal organic frameworks (MOFs), zeolites, porous clay minerals, the like, and any combination thereof.

Nonporous particles that may be included in wellbore fluid or additives for wellbore fluids in conjunction with the controlled release particle comprising Co Compound I may include, but are not limited to, sand, polymer beads, carbon black, graphite carbon, milled products from biomass, algae, plastic waste, the like, and any combination thereof.

While the foregoing methods focus on Compound I, other scale inhibitors may be used in place of Compound I in the foregoing or in combination with Compound I in the foregoing. Such scale inhibitors may be phosphonates, sulfonates, and carboxylates, or combinations thereof. Examples of phosphonate scale inhibitors may include, but are not limited to, nitrilotri(methylphosphonic acid), N,N-bis(phosphonomethyl)glycine, iminodi(methylphosphonic acid), (aminomethyl)phosphonic acid, methylenediphosphonic acid, diethylenetriaminepentakis(methylphosphonic acid), 2-hydroxyethyl imino bis(methylene)) bisphosphonic acid, amino-tris(methylenephosphonate), 1-Hydroxyethane-1, 1-diphosphonic acid, Phosphonobutane tricarboxylic acid, aminoethylethanolamine phosphonate, Hydroxyphosphono acetic acid, Bis (hexamethylene) triaminepenta (methylenephophonic acid), poly(vinyl phosphonic acid), the like, and any combination thereof. Examples of sulfonate scale inhibitors may include, but are not limited to, sulfo succinic acid, benzene sulfonic acid, naphthalene sulfonaic acid, vinyl sulfonic acid, poly vinyl sulfonic acid, styrene sulfonic acid, polystyrene sulfonic acid, the like, and any combination thereof. Examples of carboxylate scale inhibitors may include, but are not limited to, ethylenediaminetetraacetic acid (EDTA), nitrilotriacetic acid, polyacrylic acid, the like, and any combination thereof.

Further, while the foregoing methods focus on wellbore applications to mitigate scale formation on and/or corrosion of downhole wellbore tools, Compound I and controlled release particles comprising Compound I may be useful in other applications including water treatment, self-healing coatings for corrosion control, scrubbing carbon dioxide from atmosphere and/or coal fire plants, catalyst for ring opening polyaddition and/or polycondensation, and solid electrolyte for storage devices such as batteries and fuel cell.

Controlled Release Particles with Stimuli-Responsive Coatings

The present disclosure also relates to controlled release particles that comprise stimuli-responsive coatings on porous particles to allow for controlled release of a material in the pores of the porous particles. More specifically, the coating comprises at least one multi-urethane compound capable of reversibly transitioning between a condensed state and an expanded state upon exposure to a stimuli, where in the expanded state the material in the pores may exit the pores of the porous particle into the surrounding environment. As used herein, the term “multi-urethane” is a compound having two or more urethane moieties. Multi-urethanes may have 2 to 50 or more (or 2 to 24, or 6 to 18, or 8 to 20, or 8 to 30, or 26 to 40, or 30 to 50 or more) urethane moieties.

Advantageously, the multi-urethane compounds of the stimuli-responsive coating is bonded to the porous particles and is capable of reversible transition between two states: (a) a condensed state where preferred structural conformations that mitigate release of a material from the pore openings that are at least partially covered by the compound and (b) an expanded state where preferred structural conformations allow for release of the material from the pore openings that had been covered. Accordingly, if a stimulus is encountered, the multi-urethane compounds of the stimuli-responsive coating may transition to the expanded state and release a portion of the material. However, once the stimulus is removed and/or reversed, the multi-urethane compounds may transition back to the condensed state and mitigate, if not completely stop, release of the material until the desired stimulus is encountered.

Without being limited by theory, it is believed that because of the reversible transition, the controlled release particles may be reused. For example, after a first use, the controlled release particles may be collected. Then, a stimulus may be applied to place the multi-urethane compound in the expanded state and exposed to a high concentration of the material to be placed into the pores. Without being limited by theory, it is further believed that by a concentration gradient mechanism, the controlled release particles may be reloaded with the same or a different material and the multi-urethane compound transitioned back to the condensed state used in additional methods and applications.

The controlled release particles of the present disclosure comprise a porous particle, a material in the pores of the porous particle, and a coating bonded (e.g., via covalent bonding, hydrogen bonding, ionic bonding, and the like) to the surface of the porous particle. The coating comprises at least one multi-urethane compound capable of reversibly transitioning between a condensed state and an expanded state upon exposure to a stimuli, where in the expanded state the material may exit the pores of the porous particle into the surrounding environment. The environment is generally a liquid environment and the expanded state allows the material in the pores of the porous particle to move from the pores and into the liquid environment.

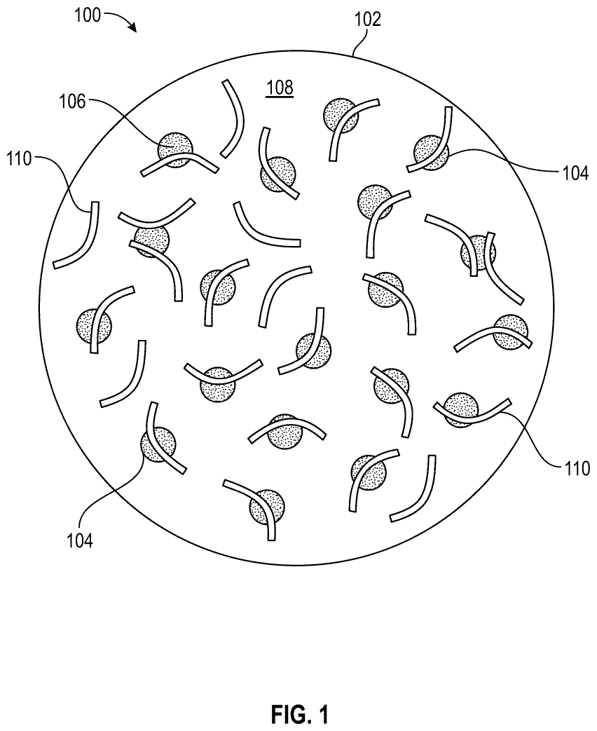

FIG. 1 is a diagram illustrating a nonlimiting example of a controlled release particle 100 of the present disclosure. The illustrated controlled release particle 100 includes a porous particle 102 having pores 104 with a material 106 therein. On a surface 108 of the porous particle 102 is a coating comprising at least one multi-urethane compound 110. In the illustrated diagram, some of the multi-urethane compound 110 extends across the outlets of the pores 104, which may prevent the release of the material 106 from the pores 104.

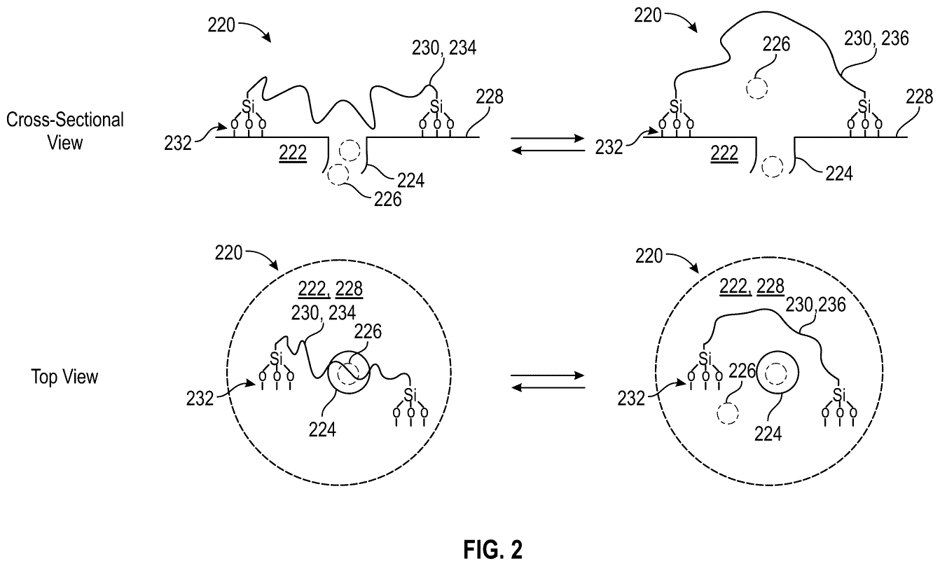

FIG. 2 is a diagram of a proposed mechanism by which the controlled release particles behave. The top proposed mechanism scheme shows a cross-sectional view of a portion of a controlled release particle 220, and the bottom proposed mechanism scheme shows a top view of a portion of a controlled release particle 220. The illustrated controlled release particle 220 includes a porous particle 222 having pores 224 with a material 226 therein. On a surface 228 of the porous particle 222 is a coating comprising at least one multi-urethane compound 230. In the illustrated diagram, the multi-urethane compound 230 comprises two terminal coupling moieties (one at each end of the multi-urethane compound 230) that are bonded 232 (illustrated here as covalent bonding but other bonding mechanisms like hydrogen bonding and ionic bonding may be achieved using different coupling moieties) to the surface 228 of the porous particle 222. The coupling moieties bond the multi-urethane compound to the surface of the porous particles.

The illustrated proposed mechanism shows the multi-urethane compound 230 in a contracted conformation 234 on the left of the mechanism and in an expanded conformation 236 on the right of the mechanism. The extended conformation 236 of the multi-urethane compound 230 extends away from the surface 228 into the surrounding environment to a greater degree than the contracted conformation 234 of the multi-urethane compound 230. The extended conformation 236 may allow for at least a portion of the material 226 to exit the pores 224 and enter the surrounding environment.

Without being limited by theory, it is believed application of a stimulus increases the multi-urethane compound's 230 accessibility to an expanded conformation 236 because the stimulus causes (a) a conformational change and/or (b) increases the degrees of freedom for the movement of the multi-urethane compound 230 to allow for the expanded conformation 236 to be more likely as compared to when the stimulus is not applied. That is, when a stimulus is applied, the probability of the multi-urethane compound 230 being in an expanded conformation 236 is greater than the probability of the multi-urethane compound 230 being in the expanded conformation 236 without said stimulation. Further, the probability of the multi-urethane compound 230 being in a contracted conformation 234 is greater when said stimulus is removed or reversed than the probability of the multi-urethane compound 230 being in the contracted conformation 234 with the stimulation being present. Herein, an “expanded state” of the multi-urethane compound refers to a condition of the multi-urethane compound where expanded conformations have a higher probability than in a “condensed state” of the multi-urethane compound. Further, the “condensed state” of the multi-urethane compound refers to a condition of the multi-urethane compound where contracted conformations have a higher probability than in the “expanded state” of the multi-urethane compound.

In preferred embodiments, the transition between states is fully reversible. That is, application of a stimulus converts the multi-urethane compound from a condensed state to an expanded state. Further, removal and/or reversal of the stimulus converts the multi-urethane compound from an expanded state to a condensed state. Therefore, the multi-urethane compound is capable of reversibly converting between a condensed state and an expanded state upon exposure to a stimuli. Advantageously, this may allow for the controlled release particles to release a portion of the material by application of a stimulus and then significantly reduce, if not stop, the release by removing and/or reversing the stimulus. The ability to control the release in such a way may allow for releasing the material in a location with greater specificity, releasing the material in more than one location with minimal release between locations, or a combination thereof.

Examples of stimuli to transition the multi-urethane compound from a condensed state to an expanded state may include, but are not limited to, a change in temperature (e.g., an increase in temperature or a decrease in temperature), a change in pH (e.g., an increase in pH or a decrease in pH), an increase in ionic strength (e.g., increase salt concentration), an application of UV light, an application of an electric current, an application of a magnetic field, an application of an electro-magnetic field, an application of sonic energy, a presence of an enzyme, a presence of a microbial organism, a presence of hydrogen sulfide gas, the like, and any combination thereof.

By way of nonlimiting example, the multi-urethane compound may have a composition that at room temperature is at least partially crystalline having preferred conformations that are contracted. Then, upon increasing the temperature (e.g., to a temperature above a softening point of the multi-urethane compound) the multi-urethane compound may become more mobile such that expanded conformations are more probable than at room temperature. Such expanded conformations may allow for the material to exit pores. Then, decreasing the temperature may cause the bi-urethane compound to take on the contracted conformations preferred by the at least partially crystalline structure of the bi-urethane compound.

The foregoing nonlimiting example may be applied to the other stimuli described herein.

The multi-urethane compounds described herein comprise two or more coupling moieties that are capable of bonding (e.g., covalent bonding, hydrogen bonding, ionic bonding, and the like) to the surface of the porous particles. Examples of coupling moieties may include, but are not limited to, hydroxyls, amines, silanes, titanates, zirconates, vanadates, the like, and any combination thereof (e.g., a terminal silane moiety at one end and a terminal titanate moiety at the other). The foregoing moieties may be capable of one or more types of bonding mechanisms to the surface of the porous particles where the type of bonding mechanism may depend on, among other things, the surface chemistry of the porous particles, the coupling moiety, the conditions for coupling, the desired stimulus, the like, and any combination thereof.

Examples of coupling moieties that may be capable of covalent bonding with the surface of the porous particles may include, but are not limited to —Si(OR)ₓ where R is hydrogen or methyl and x is 1-3, —Ti(OR)_{y} where R is hydrogen or methyl and x is 1-3, —Zr(OR)_{z} where R is hydrogen or methyl and x is 1-3; —V(OR)_{w} where R is hydrogen or methyl and w is 1-3, the like, and any combination thereof. Accordingly, multi-urethane compounds may be bis-silane, multi-urethane compounds; bis-titanate, multi-urethane compounds; bis-zirconate, multi-urethane compounds; bis-vanadate, multi-urethane compounds; silane, titanate, multi-urethane compounds; silane, zirconate, multi-urethane compounds; silane, vanadate, multi-urethane compounds; titanate, zirconate, multi-urethane compounds; titanate, vanadate, multi-urethane compounds; or zirconate, vanadate, multi-urethane compounds. Any combination of the foregoing may be used in conjunction with the porous particles.

Specific, nonlimiting examples of bis-silane, multi-urethane (specifically, bis-urethanes in these examples) compounds include the following compounds.

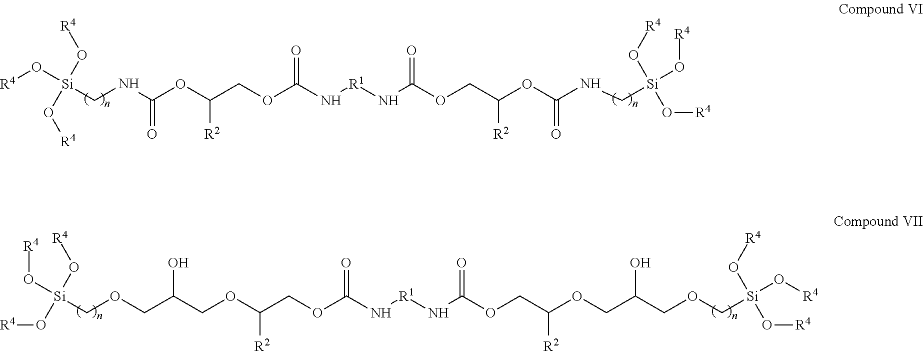

where n=1-12;
R¹=—CH₂—CH₂—,
—CH₂—CH₂—NH—CH₂—CH₂—,
—CH₂—CH₂—NH—CH₂—CH₂—NH—CH₂—CH₂—,
—CH₂—CH₂—NH—CH₂—CH₂—NH—CH₂—CH₂—NH—CH₂—CH₂—,

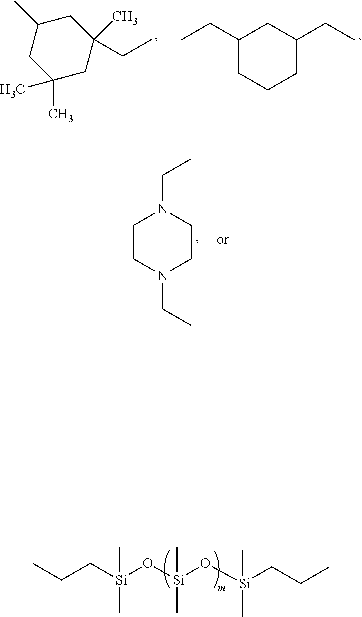

where m is 1-500;
R²=hydrogen or methyl; and
R⁴=methyl, ethyl, i-propyl, or t-butyl.

Examples of porous particles may include, but are not limited to, a porous carbon particle (e.g., activated charcoal, activated carbon, biochar, carbon nanotubes, and/or graphene), a porous silica particle (e.g., amorphous and/or precipitated silica), a porous natural mineral particle (e.g., diatomite, sandstone, calcite, stellerite, and/or vitric tuff), and a porous synthetic mineral particle (e.g., zeolites, metal-organic frameworks, layered double hydroxides, hydrated calcium aluminum silicate, and/or hydrated aluminum silicate), the like, and any combination thereof.

The porous particles may have weight average diameter of about 10 nm to about 2000 μm (or about 10 nm to about 500 nm, or about 100 nm to about 2 μm, or about 250 nm to about 1 μm, or about 1 μm to about 10 μm, or about 5 μm to about 20 μm, or about 10 μm to about 100 μm, or about 50 μm to about 250 μm, or about 200 μm to about 500 μm, or about 250 μm to about 1000 μm, or about 500 μm to about 2000 μm).

The porous particles may have a N₂ BET surface area of about 100 m²/g or greater (or about 100 m²/g to about 2000 m²/g, or about 100 m²/g to about 1000 m²/g, or about 500 m²/g to about 1500 m²/g, or about 1000 m²/g to about 2000 m²/g).

Examples of materials that may be placed in the pores include, but are not limited to, a small molecule, oligomers, DNA, RNA, a bacteria, a fungi, the like, and any combination thereof. As used herein, the term “small molecule” refers to a compound having a molecular weight of about 900 g/mol or less. As used herein, the term “oligomer” refers to a compound having a molecular weight of above 901 g/mol and below 30,000 g/mol.

Examples of small molecules may include, but are not limited to, scale inhibitors, corrosion inhibitors, asphaltene precipitation inhibitors, microbially produced sulfate and nitrate inhibitors, hydrogen sulfide scavengers, surfactants, lubricants, chelating agents, the like, and any combination thereof.

Examples of scale inhibitors may include, but are not limited to, acrylic acid oligomers, maleic acid oligomers, nitrilotri(methylphosphonic acid), Compound I (e.g., Compound II, Compound III, Compound IV, and Compound V), n,n-bis(phosphonomethyl)glycine, iminodi(methylphosphonic acid), (aminomethyl)phosphonic acid, methylenediphosphonic acid, diethylenetriaminepentakis(methylphosphonic acid), 2-hydroxyethyl imino bis(methylene)) bisphosphonic acid, amino-tris(methylenephosphonate), poly(vinyl phosphonic acid), poly-phosphono carboxylic acid (PPCA), sulfo succinic acid, benzene sulfonic acid, naphthalene sulfonaic acid, vinyl sulfonic acid, poly vinyl sulfonic acid, styrene sulfonic acid, polystyrene sulfonic acid, ETDA, nitrilotriacetic acid, polyacrylic acid, the like, and any combination thereof.

Examples of corrosion inhibitors may include, but are not limited to, hexamine, phenylenediamine, dimethylethanolamine, sulfites, ascorbic acid, benzotriazole, imidazole, benzimidazole, thiazole, benzothiazole, Schiff base, 8-hydroxyl quinoline, methylene bisthiocyanate (MBT), isothiazolone, tetrakis (hydroxymethyl) phosphonium sulfate (THPS), 2,2-dibromo-3-nitrilopropioamide (DBNPA) the like, and any combination thereof.

Examples of asphaltene precipitation inhibitors may include, but are not limited to, dodecylphenol (DDPh), the like, and any combination thereof.

Examples of surfactants may include, but are not limited to, polyoxyethylene alkyl ethers, polyoxyethylene alkylphenol ethers, polyoxyethylene lauryl ethers, polyoxyethylene sorbitan monoOleates, polyoxyethylene alkyl esters, polyoxyethylene sorbitan alkyl esters, polyethylene glycol, polypropylene glycol, diethylene glycol, ethoxylated trimethylnonanols, polyoxyalkylene glycol modified polysiloxane surfactants, octyl trimethyl ammonium hydroxide, dodecyl trimethyl ammonium hydroxide, hexadecyl trimethyl ammonium hydroxide, octyl dimethyl benzyl ammonium hydroxide, decyl dimethyl benzyl ammonium hydroxide, didodecyl dimethyl ammonium hydroxide, dioctadecyl dimethyl ammonium hydroxide, tallow trimethyl ammonium hydroxide, coco trimethyl ammonium hydroxide, cetyl trimethyl ammonium chloride, cetyl pyridinium chloride, alkyl sulphates (e.g., lauryl sulphate), hexylbenzenesulfonic acid, octylbenzenesulfonic acid, decylbenzenesulfonic acid, dodecylbenzenesulfonic acid, cetylbenzenesulfonic acid, myristylbenzenesulfonic acid, the sulphate esters of monoalkyl polyoxyethylene ethers, alkylnapthylsulfonic acid, alkali metal sulfoccinates, sulfonated glyceryl esters of fatty acids (e.g., sulfonated monoglycerides of coconut oil acids), sodium octahydroanthracene sulfonate, alkali metal alkyl sulphates, ester sulphates, alkarylsulfonates, the like, and any combination thereof.

Examples of lubricants may include, but are not limited to, polyalpha olefins, synthetic esters, polyalkylene glycols, phosphate esters, perfluoropolyether, alkylated naphthalenes, silicate esters, ionic fluids, alkylated cyclopentanes (MAC), calcium stearate, epoxidized vegetable oils, epoxidized algal oil, epoxidized tallow, the like, and any combination thereof.

Examples of chelating agents may include, but are not limited to, ethylenediaminetetraacetic acid (EDTA), nitrilotriacetic acid, n-hydroxyethylethylenediaminetriacetic acid (HEDTA), citric acid, itaconic acid, aspartic acid, polyitaconic acid, polyaspartic acid, the like, and any combination thereof.

Examples of bacteria may include, but are not limited to, Bacillus lichenformis, Leuconostoc mesenteroides, Xanthomonas campestris, Acinetobacter calcoacetiens, Arthrobacter paraffeninues, Bacillus Sp., Clostridium Sp., Pseudomonas Sp., Rhodococcus erythropolis, Mycobacterium sp, the like, and any combination thereof.

Examples of fungi may include, but are not limited to Torulopsis bombicola sp, Candida bombicola, Candida lipolytica, Candida ishiwadae, Candida batistae, Aspergillus ustus, Trichosporon ashii, the like, and any combination thereof.

For example, deoxy ribonucleic acid (DNA) may contain base pairs between 50 and 5000 and may be derived from bacterial or mammalian origin.

For example, ribonucleic acid (RNA) may be obtained from RNA polymerase-mediated transcription from a linearized DNA template.

Methods of Producing Controlled Release Particles with Stimuli-Responsive Coatings

The multi-urethane compound may be produced by any suitable synthetic routes. For example, the multi-urethane compound may be produced by first synthesizing a multi-urethane backbone by reacting an amine and a cyclic carbonate. In said methods, synthesis of the multi-urethane backbone does not use an isocyanate. The multi-urethane backbone may have a hydroxyl functionality, a carboxyl functionality, a thiol functionality, a vinyl functionality, or a combination thereof that may be utilized in the next step of the synthesis. In the second step, the multi-urethane backbone (via one or more of the foregoing functionalities) may be reacted with coupling compounds that provide the coupling moieties on the resultant multi-urethane compound that are capable of bonding to the surface of the porous particles (e.g., silanes for use with porous silica particles). The resultant product is the multi-urethane compound.

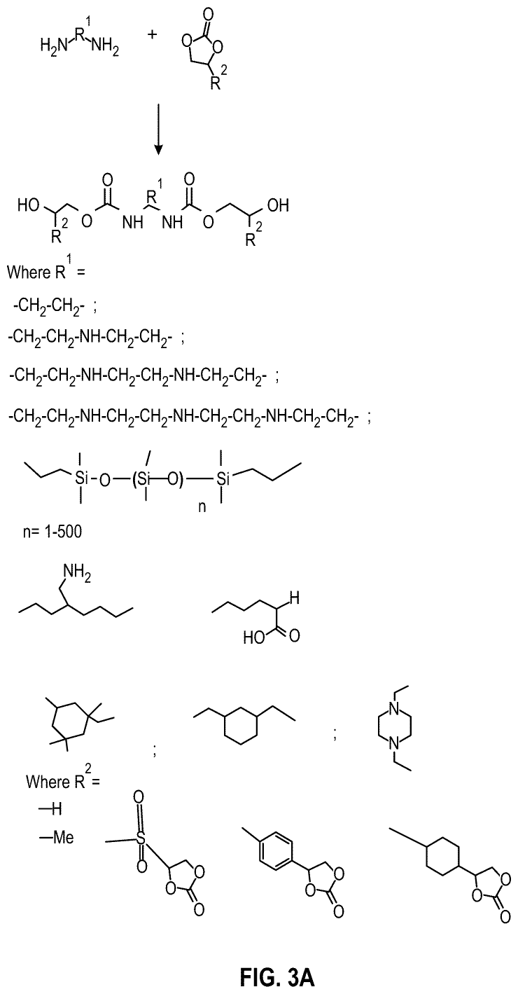

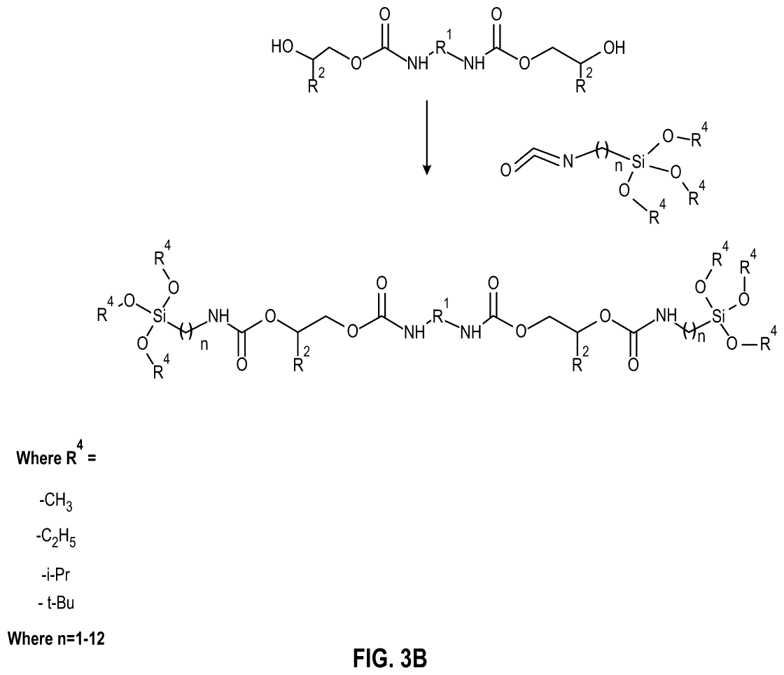

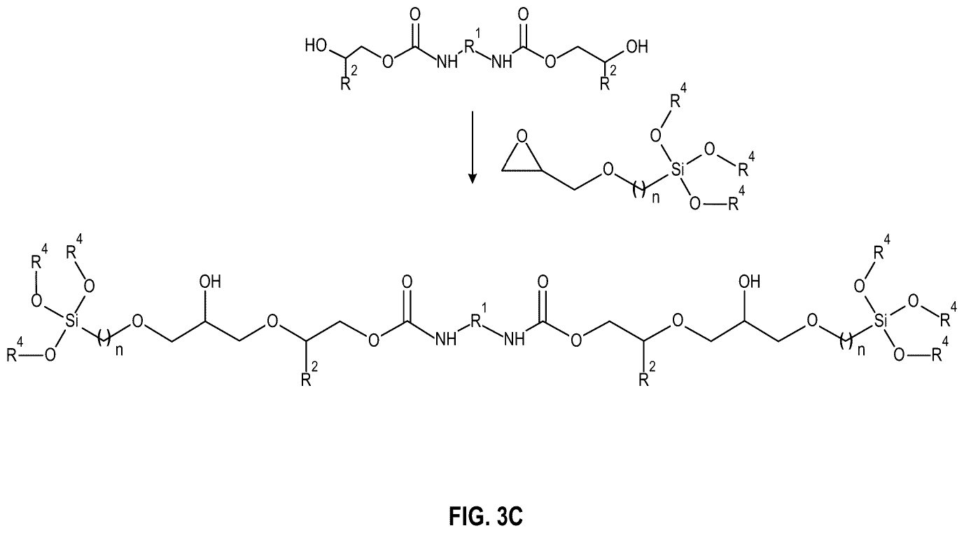

By way of nonlimiting example, FIG. 3A illustrates a reaction scheme for synthesizing the multi-urethane backbone of Compounds VI and VII. By way of further nonlimiting example, FIGS. 3B and 3C illustrate reaction schemes for producing Compounds VI and VII, respectively, from the multi-urethane backbone of FIG. 3A.

Reaction conditions for producing the multi-urethane backbone may include a temperature of about 35° C. to about 100° C. (or about 35° C. to about 60° C., or about 50° C. to about 80° C., or about 70° C. to about 100° C.), a time of about 1 hour to about 24 hours (about 1 hour to about 12 hours, or about 8 hours to about 18 hours, or about 12 hours to about 24 hours). Further, the reaction to produce the multi-urethane backbone may be performed under an inert atmosphere (e.g., nitrogen, argon, and the like).

Examples of amines suitable for use in synthesizing the multi-urethane backbone may include, but are not limited to, ethylene diamine, diethylene triamine, triethylene tetramine, tetrethylene pentaamine, 4-(aminomethyl)octane-1,8-diamine, diaminopropyl terminated polydimethylsiloxane molecular weight above 300 and below 30,000, 2,6-diaminohexanoic acid (also referred as lysine), isophorone diamine, cyclohexyl diamine, hyperbranched amidoamine, the like, and any combination thereof.

Examples of cyclic carbonates suitable for use in synthesizing the multi-urethane backbone may include, but are not limited to, ethylene carbonate, propylene carbonate, glycerol carbonate, styrene carbonate, cyclic carbonate derivatives derived from epoxidized vinyl monomers, glycidyl ether terminated polyols such as glycerine, ethylene glycol, propylene glycol, butylene glycol, trimethylol propane, pentaerythritol, sorbitol, sucrose, glucose, fructose trehalose, epoxidized vegetable oils, the like, and any combination thereof.

Reaction conditions for producing the multi-urethane compound (e.g., the reaction between the multi-urethane backbone and the coupling compounds) may include a temperature of about 35° C. to about 100° C. (or about 35° C. to about 60° C., or about 50° C. to about 80° C., or about 70° C. to about 100° C.), a time of about 30 minutes to about 12 hours (about 30 minutes to about 6 hours, or about 1 hour to about 8 hours, or about 6 hours to about 12 hours). Further, the reaction to produce the multi-urethane backbone may be performed under an inert atmosphere (e.g., nitrogen, argon, and the like).

Examples of coupling compounds that yield the coupling moieties capable of covalently bonding to the surface of the porous particles may include, but are not limited to, tetraethyl orthosilicate, trimethoxy[2-(7-oxabicyclo[4.1.0]hept-3-yl)ethyl]silane, (3-aminopropyl)tris(trimethylsiloxy)silane, (3-glycidyloxypropyl)triethoxysilane, 3-(triethoxysilyl)propyl isocyanate, titanium(IV) (triethanolaminato)isopropoxide, titanium(IV) bis(ammonium lactato)dihydroxide, titanium(IV) isopropoxide, titanium(IV) ethoxide, titanium(IV) isopropoxide, titanium(IV) 2-ethylhexyloxide, titanium(IV) oxyacetylacetonate zirconium(IV) ethoxide, zirconium(IV) isopropoxide, zirconium(IV) butoxide, zirconium(IV) acetylacetonate, the like, and any combination thereof.

The two reactions may be performed in separate vessels (e.g., producing the multi-urethane backbone, isolating the multi-urethane backbone, and producing the multi-urethane compound) or in the same vessel (e.g., producing the multi-urethane backbone and adding coupling compounds to produce the multi-urethane backbone).

The loading of the materials into the pores of the porous particles may be by any suitable method. For example, a concentrated solution or suspension of the material (e.g., about 65 parts to about 80 parts per 100 parts of solvent) may be slowly added to the porous particles (about 20 parts to about 35 parts) under agitation (e.g., using a paddle mixer or ribbon blender or bucket mixer or drum mixer) and dried to a final moisture content below 25 wt %, and preferably below 10 wt %. A weight ratio of the concentrated solution or suspension to the porous particles may be about 65:35 to about 80:20 (or about 65:35 to about 75:25, or about 70:30 to about 80:20).

The coating of the porous particles having materials therein with the multi-urethane compounds to produce the controlled release particles may be by any suitable method. For example, wet coating methods may be used. For example, the multi-urethane compounds may be dispersed in water and spray coated. Spray coating may be achieved using, for example, a fluidized bed Wurster coating process wherein the multi-urethane compound dispersion is sprayed from the bottom of the fluidized bed. The fluidized bed coater may be operated at an air flow in the range of about 2 standard cubic feet per minute (SCFM) to about 30 SCFM, a magnaflo pressure in the range of about 20 psi to about 80 psi, inlet temperature in the range of about 35° C. to about 90° C., a product temperature in the range of about 28° C. to about 65° C., an atomizing air pressure in the range of about 2 psi to about 30 psi, and a liquid dosage pump set at forward motion with a speed in the range of about 2 rpm to about 30 rpm. After completion of the spray process, the product may be allowed to dry to a final moisture content less than about 25 wt %, and preferably less than about 10 wt %.

In another wet coating method example, the porous particles having materials therein may be spray coated in a ribbon blender with the multi-urethane compounds at temperatures in the range of about 40° C. and about 90° C., at atmospheric pressure±3 psi, and for about 6 hours to facilitate the bonding of the multi-urethane compounds to the surface of the porous particles.

In yet another wet coating method example, the porous particles having materials therein may be coated with the multi-urethane compounds using a fluidized bed coater, wherein a water dispersion of multi-urethane compounds may be sprayed from the top of the fluidized bed. The fluidized bed coater may be operated at an air flow in the range of about 2 SCFM to about 30 SCFM, a magnaflo pressure set in the range of about 20 psi to about 80 psi, and an inlet temperature in the range of about 35° C. to about 90° C. After the completion of spray process the product may be allowed to dry to a final moisture content less than about 25 wt %, and preferable less than about 10 wt %.

In yet another wet coating method example, the porous particles having materials therein may be dispersed in a solvent (e.g., acetone, ethanol, isopropanol, the like, and any combinations thereof). The multi-urethane compounds may be mixed with the dispersion in a reactor. The contents of the reactor may be mixed at a temperature in the range of about 30° C. to about 60° C. so that the solvents in the reactor evaporate (which may optionally be assisted by applying a vacuum) to yield the final product as a powder with a moisture (or solvent) content below about 10 wt %.

In yet another wet coating method example, the porous particles having materials therein may be dispersed in paraffin oil. The multi-urethane compounds may be mixed with the dispersion in a reactor. The contents of the reactor may be mixed at a temperature in the range of about 80° C. to about 100° C. under an inert atmosphere for about 4 hours to about 8 hours. The product may then be contacted with an excess of hexane and filtered to isolate the product. The product may be dried at room temperature to yield a powder with a moisture content below about 10 wt %.

Independent of the production method, a weight ratio of porous particles having materials therein to multi-urethane compounds may be about 100:2 to about 100:50 (or about 100:2 to about 100:20, or about 100:10 to about 100:25, or about 100:15 to about 100:30, or about 100:25 to about 100:50).

The controlled release particles may be used as a solid additive (alone or in combination with other solid additives) and added to a fluid for a desired application.

Alternatively, the controlled release particles (alone or in combination with other solid additives) may be dispersed in a fluid to yield a slurry. The fluid of the slurry may be an aqueous fluid or an oil fluid. Examples of aqueous fluids may include, but are not limited to, fresh water, tap water, distilled water, deionized water, saltwater, and the like. Examples of oil fluids may include, but are not limited to, petroleum, kerosene, synthetic oil, paraffin, mineral oil, the like, and any combination thereof.

### Oil and Gas Applications of Controlled Release Particles

The Compound I and/or controlled release particles described herein (e.g., controlled release particles consisting of Compound I, controlled release particles comprising Compound I and a porous particle, controlled release particles with stimuli-responsive coatings comprising Compound I, and/or controlled release particles with stimuli-responsive coatings comprising a scale-inhibitor other than Compound I) may be suitable for use as an additive in a fluid associated with a wellbore operation. Examples of wellbore operations may include, but are not limited to, a drilling operation, a stimulation operation, an acidizing operation, an acid-fracturing operation, a sand-control operation, a completion operation, a scale-inhibiting operation, a water-blocking operation, a clay-stabilizer operation, a fracturing operation, a propping operation, a gravel-packing operation, a wellbore-strengthening operation, a sag-control operation, the like, and any combination thereof.

A wellbore operation may comprise: introducing controlled release particles described herein (e.g., controlled release particles consisting of Compound I, controlled release particles comprising Compound I and a porous particle, controlled release particles with stimuli-responsive coatings comprising Compound I, and/or controlled release particles with stimuli-responsive coatings comprising a scale-inhibitor other than Compound I) into a wellbore penetrating a subterranean formation; and exposing the controlled release particle to a stimuli so as to (a) transition the coating from a condensed state to an expanded state and (b) release at least a portion of the material from the pores of the porous particle. The method may further comprise: reversing and/or removing the stimuli so as to transition the coating from the expanded state to the condensed state. The exposure to the stimuli may occur prior to introduction into the wellbore, during introduction into the wellbore, while in the wellbore, while in the subterranean formation (if the controlled release particle penetrates into the subterranean formation), or any combination thereof. The reversal and/or removal of the stimuli occurs after exposure of the stimuli and may occur prior to introduction into the wellbore, during introduction into the wellbore, while in the wellbore, while in the subterranean formation (if the a controlled release particle penetrates into the subterranean formation), or any combination thereof. The steps of (a) exposing the stimuli and (b) reversing and/or removing the stimuli may be repeated one or more times.

By way of nonlimiting example, an acidizing operation may comprise: introducing controlled release particles described herein (e.g., controlled release particles consisting of Compound I, controlled release particles comprising Compound I and a porous particle, controlled release particles with stimuli-responsive coatings comprising Compound I, and/or controlled release particles with stimuli-responsive coatings comprising a scale-inhibitor other than Compound I) into a wellbore penetrating a subterranean formation, wherein the material comprises a scale inhibitor and/or a corrosion inhibitor; exposing the controlled release particle to a stimuli (e.g., an increase in temperature as a result of being downhole) so as to (a) transition the coating from a condensed state to an expanded state and (b) release at least a portion of the material from the pores of the porous particle; and mitigating scale formation on and/or corrosion of downhole wellbore tools (e.g., tubulars).

Advantageously, the preparation methods for Compound I and controlled release particles consisting of Compound I allow for on-site or in situ production of Compound I via precipitation. That is, Compound I or particles thereof may be produced on-site by mixing a first fluid comprising a metal salt described herein and a second fluid comprising [bis[2-[bis(phosphonomethyl)amino]ethyl]amino]methylphosphonic acid. The resultant mixture may comprise precipitated particles of Compound I that can be stored, further processed, or directly introduced into the wellbore per the methods above.

The mixing may be in-line mixing (e.g., using a T-valve) of the first fluid and the second fluid. The concentration of the active components in the first and second fluids should be sufficiently dilute to mitigate (or prevent) clogging of the tubing where the two fluids meet and Compound I precipitates.

In another example, a mixer containing water may be stirred where the first fluid and the second fluid are added to the water. Precipitates of Compound I may be collected from the mixer (e.g., via filtration, settling, or the like) and introduced to the wellbore.

### EXAMPLE EMBODIMENTS

Embodiment 1. A composition comprising: Compound I.

Embodiment 2. The composition of Embodiment 1, wherein the metal cation includes a metal selected from the group consisting of: zinc, nickel, cadmium, manganese, aluminum, scandium, gallium, lanthanum, iron, cobalt, boron, silicon, tin, bismuth, titanium, vanadium, chromium, tungsten, and copper.

Embodiment 3. The composition of any preceding Embodiment further comprising a porous particle, a nonporous particle, or a mixture of the porous particle and the nonporous particle.

Embodiment 4. The composition of any of Embodiments 1-2, wherein the Compound I is in a form of particulates of Compound I.

Embodiment 5. A method comprising: absorbing the composition of any one of Embodiments 1-2 into at least a portion of the pores of a porous particle.

Embodiment 6. A method comprising: introducing a wellbore fluid into a wellbore penetrating a subterranean formation, wherein the wellbore fluid comprises the composition of any one of Embodiments 1-4.

Embodiment 7. A method comprising: introducing the composition of any one of Embodiments 1-4 into a wellbore penetrating a subterranean formation; and inhibiting scale in a portion of the wellbore and/or the subterranean formation.

Embodiment 8. A method comprising: introducing the composition of Embodiment 4 into a wellbore penetrating a subterranean formation; heating the Compound I to a temperature of 150° F. or greater while in the wellbore and/or in the subterranean formation so as to release the Compound I from the particulates; and inhibiting scale in a portion of the wellbore and/or the subterranean formation.

Embodiment 9. A composition comprising: a porous particle; and one or more of Compound I absorbed in pores of the porous particle.

Embodiment 10. A method comprising: mixing a metal salt in water with the [bis[2-[bis(phosphonomethyl)amino]ethyl]amino]methylphosphonic acid; precipitating Compound I; and separating the Compound I from at least a portion of water.

Embodiment 11. The method of Embodiment 10, wherein a molar ratio of [bis[2-[bis(phosphonomethyl)amino]ethyl]amino]methylphosphonic acid to a metal of the metal salt is 0.5:1 to 1:10.

Embodiment 12. The method of Embodiment 10 or 11, wherein a metal cation of the metal salt includes a metal selected from the group consisting of: zinc, nickel, cadmium, manganese, aluminum, scandium, gallium, lanthanum, iron, cobalt, boron, silicon, tin, bismuth, titanium, vanadium, chromium, tungsten, and copper.

Embodiment 13. The method of any of Embodiments 10-12, wherein the Compound I after the separating is in a form of particulates of Compound I.

Embodiment 14. The method of any of Embodiments 10-13 further comprising: introducing the Compound I into a wellbore penetrating a subterranean formation.

Embodiment 15. The method of any of Embodiments 10-13 further comprising: introducing the Compound I into a wellbore penetrating a subterranean formation; and inhibiting scale in a portion of the wellbore and/or the subterranean formation.

Embodiment 16. The method of any of Embodiments 10-13, wherein the Compound I after the separating is in a form of particulates of Compound I, and wherein the method further comprises: introducing the Compound I into a wellbore penetrating a subterranean formation; heating the Compound I to a temperature of 150° F. or greater while in the wellbore and/or in the subterranean formation so as to release the Compound I from the particulates; and inhibiting scale in a portion of the wellbore and/or the subterranean formation.

Embodiment 17. A method comprising: mixing, at a wellsite, a metal salt in water with [bis[2-[bis(phosphonomethyl)amino]ethyl]amino]methylphosphonic acid; precipitating Compound I; and introducing the Compound I into a wellbore penetrating a subterranean formation.

Embodiment 18. The method of Embodiment 17, wherein the mixing includes in-line mixing of the metal salt in water and the [bis[2-[bis(phosphonomethyl)amino]ethyl]amino]methylphosphonic acid.

Embodiment 19. The method of Embodiment 17, wherein the mixing includes adding the metal salt in water and the [bis[2-[bis(phosphonomethyl)amino]ethyl]amino]methylphosphonic acid separately to a fluid comprising water.

Embodiment 20. The method of any of Embodiments 17-19, wherein the Compound I is in a form of particulates of Compound I when introducing into the wellbore.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

To facilitate a better understanding of the embodiments of the present invention, the following examples of preferred or representative embodiments are given. In no way should the following examples be read to limit, or to define, the scope of the invention.

### EXAMPLES

Example 1 (Inventive)—Synthesis of Pentazinc;[bis[2-[bis(phosphonomethyl)amino]ethyl]amino]methylphosphonic acid. About 40 g of zinc acetate dihydrate was added slowly (about 5 g at a time) to 100 mL of distilled water at 45° C. After dissolution of the zinc acetate dihydrate, the zinc acetate dihydrate solution was mixed with 40 g of diethylenetriaminepenta(methylenephosphonic acid) (supplied as 50 w/v % in water). The mixture was stirred for 15 minutes then allowed to sit undisturbed for 1 hour. The fluid of the resulting mixture was decanted, and the remaining precipitate was washed with water (6 times with 200 mL of water each wash) until the wash water was neutral (per litmus paper). The precipitate was then dried in a vacuum oven at 120° C. for 24 hours. Nuclear magnetic resonance spectroscopy, Fourier-transform infrared spectroscopy, and other analytical techniques were used to confirm the product structure was that of Compound I.

Example 2 (Inventive)—Synthesis of Pentazinc;[bis[2-[bis(phosphonomethyl)amino]ethyl]amino]methylphosphonic acid. About 25 g of zinc chloride was added slowly (about 5 g at a time) to 30 mL of distilled water. After dissolution of the zinc chloride, the zinc chloride solution was mixed with 40 g of diethylenetriaminepenta(methylenephosphonic acid) (supplied as 50 w/v % in water). The mixture was stirred for 15 minutes then allowed to sit undisturbed for 1 hour. The resulting product was added to 500 mL of distilled water where a white precipitate formed and was allowed to settle for 15 minutes. The fluid was decanted, and the remaining precipitate was washed with water (6 times with 200 mL of water each wash) until the wash water was neutral (per litmus paper). The precipitate was then dried in a vacuum oven at 120° C. for 24 hours. Nuclear magnetic resonance spectroscopy, Fourier-transform infrared spectroscopy, and other analytical techniques were used to confirm the product structure was that of Compound I.

Example 3 (Inventive)—Production of a solid scale inhibitor comprising Pentazinc;[bis[2-[bis(phosphonomethyl)amino]ethyl]amino]methylphosphonic acid and nonporous particles. About 3.3 lbs of zinc acetate dihydrate were slowly added (about 25-50 g per addition) to 1 gallon of tap water at room temperature. The resulting solution was mixed with about 0.4 gallons of diethylenetriaminepenta(methylenephosphonic acid) (supplied as 50 w/v % in water). A white precipitate was formed. The mixture was mixed for an additional 15 minutes then allowed to sit undisturbed for 1 hour. The fluid was decanted. About 4.95 lbs of sand was added slowly to the precipitated solid and mechanically stirred. The sand absorbs the remaining water present in the precipitate. The resulting slurry was allowed to dry in an air circulatory oven at 90° C. where mixing occurred occasionally to facilitate drying.

Example 4 (Inventive)—Production of a solid scale inhibitor comprising Pentazinc;[bis[2-[bis(phosphonomethyl)amino]ethyl]amino]methylphosphonic acid and a mixture of porous and nonporous particles. Example 3 was repeated except with a mixture of about 3 lbs of sand and 1.95 lbs of HI-SIL® 213 (porous silica particles, available from PPG Industries, Inc.) rather than about 4.95 lbs of sand.

Example 5 (Control). About 35 grams of HI-SIL® 213 was mixed with about 65 grams of diethylenetriaminepenta(methylenephosphonic acid) (supplied as 50 w/v % in water) for about 30 minutes.

### Example 6—Controlled Release Testing

Static release procedure:
1. 2 g of solids (see Table 1) were added to 100 g of distilled water.
2. Samples were allowed to sit for 24 hours at an elevated temperature (see Table 1).
3. Solids were filtered out of the fluid using a 45 μm filter.
   a. Solids were then transferred to a new container and 100 g of distilled water were added.
   b. Fluid sample collected was prepared for ICP (inductively coupled plasma) mass spectrometry.
      i. Phosphorous in the fluid was detected and phosphate residuals were determined.
      ii. 3.066×[phosphorous]=PO₄ residual concentration
4. Step C was repeated at the following time intervals (total exposure hours).
   a. 48 hours and 96 hours.

The static release results are presented in Table 1.

TABLE 1

| | Concentration of Residual PO₄ | | |
|---|---|---|---|
| | Example 5 | Inventive | Inventive |
| | Control at | Example 4 | Example 4 |
| Hours | 75° F. | at 75° F. | 150° F. |
| 0 | 0 | 0 | 0 |
| 24 | 50,842 | 1,097 | 1,038 |
| 48 | 4,576 | 604 | 530 |
| 96 | 961 | 401 | 307 |

The static tests suggest that the scale inhibitor continues to be released into fluid phase after 96 hours of exposure.

### Dynamic Release Procedure:

1. Test columns was packed with a mixture of 100 mesh sand and the solid sample (Table 3) according to 2% solids (12.8 g) and sand (640 g).
2. The test fluid was heated to a test temperature of 150° F., and heating was maintained for duration of test.
3. Column fluid volume 200 mL (1 Pore Volume or PV).
4. Fluid was flowed through the column at a rate of 1 PV per 2.00 minutes.
5. Effluent samples were collected at the start of each pore volume.
   a. Samples were collected at 1, 2, 3, 4, 5, 10, 15, 20, 25, 50, 100, 200, 500, 1000 PVs (Table 2).
6. Each effluent sample collected was prepared for ICP mass spectrometry.
   a. Phosphorous in the fluid was detected and phosphate residuals were determined.
   b. 3.066×[phosphorous]=PO₄ residual concentration.

TABLE 2

| Pore | Total Volume | |
|---|---|---|
| Volume | of Water (gal) | Minutes |
| 0 | 0.00 | 0 |
| 1 | 0.05 | 2 |
| 2 | 0.11 | 4 |
| 3 | 0.16 | 6 |
| 4 | 0.21 | 8 |
| 5 | 0.26 | 10 |
| 10 | 0.53 | 20 |
| 25 | 1.32 | 50 |
| 50 | 2.64 | 100 |
| 75 | 3.96 | 150 |
| 100 | 5.29 | 200 |
| 250 | 13.21 | 500 |
| 500 | 26.43 | 1000 |
| 800 | 42.28 | 1600 |
| 1000 | 52.85 | 2000 |

TABLE 3

| Pore | Inventive | Pore | Inventive |
|---|---|---|---|
| Volume | Example 3 | Volume | Example 4 |
| 1 | 118986.74 | 1 | 936.63 |
| 2 | 9405.85 | 2 | 600.77 |
| 3 | 4390.44 | 3 | 348.36 |
| 4 | 2111.56 | 4 | 237.89 |
| 5 | 1514.82 | 5 | 184.67 |
| 10 | 378.2 | 10 | 111.69 |
| 25 | 64.51 | 25 | 45.96 |
| | | 150 | 40.32 |
| 250 | 26.21 | | |
| 404 | 10.08 | | |
| 555 | 2.42 | | |

The dynamic tests showed the delayed release of scale inhibitor.

Example 7 (Inventive)—Synthesis of [bis[2-[bis(phosphonomethyl)amino]ethyl]amino]methylphosphonic acid mono aluminum salt. About 43.2 grams of aluminum sulfate octahydrate (Aldrich Chemicals) was added to 1 liter of room temperature water and stirred until dissolved. Then, 150.2 grams of [bis[2-[bis(phosphonomethyl)amino]ethyl]amino]methylphosphonic acid (LFS 312, supplied by LFS chemical) was added to the solution. The resultant gelatinous precipitate was filtered and washed with water until the filtrate was neutral to litmus paper. The washed and filtered gelatinous precipitate was dried at 120° C. for 4 hours to produce free flowing powder of [bis[2-[bis(phosphonomethyl)amino]ethyl]amino]methylphosphonic acid mono aluminum salt.

Nuclear magnetic resonance spectroscopy, Fourier-transform infrared spectroscopy, and other analytical techniques were used to confirm the product structure was that of Compound III.

Example 8 (Inventive)—Controlled release testing. The release of active scale inhibitor (product of Example 7) at room temperature was measured using the above-described static release procedure. In this example, 2 grams of solids obtained from Example 7 were added to 100 g of distilled water. The sample was allowed to sit for 24 hours at room temperature (75° F.) or 160° F. The solid was filtered out of the fluid using a 45 μm filter. The solid was then transferred to a new container and 100 g of distilled water were added. The process was repeated and the fluid samples that were collected at specified time intervals were analyzed using ICP mass spectrometry. The residual phosphate released from the product at various time intervals is given below in Table 4. The static tests suggested the scale inhibitor continues to be released into fluid phase after 72 hours of exposure to water.

TABLE 4

| | Phosphate | Phosphate |
|---|---|---|
| Time | ion (ppm) | ion (ppm) |
| (hours) | (room temperature) | (160° F.) |
| 0 | 0 | 0 |
| 24 | 19,891 | 39,352 |
| 48 | 11,665 | 11,289 |
| 72 | 6,693 | 6,706 |

Example 9 (Inventive)—Preparation of [bis[2-[bis(phosphonomethyl)amino]ethyl]amino]methylphosphonic acid di aluminum salt. About 145.5 grams of aluminum sulfate octahydrate (Aldrich Chemicals) may be added to 1 liter of room temperature water and stirred until dissolved. Then, 250 grams of [bis[2-[bis(phosphonomethyl)amino]ethyl]amino]methylphosphonic acid (LFS 312, supplied by LFS chemical) may be added to the solution. The resultant gelatinous precipitate may be filtered and washed with water until the filtrate was neutral to litmus paper. The washed and filtered gelatinous precipitate may be dried at 120° C. for 6 hours to produce free flowing powder of [bis[2-[bis(phosphonomethyl)amino]ethyl]amino]methylphosphonic acid di aluminum salt.

Example 10 (Inventive)—Preparation of [bis[2-[bis(phosphonomethyl)amino]ethyl]amino]methylphosphonic acid tri aluminum salt. About 218.6 grams of aluminum sulfate octahydrate (Aldrich Chemicals) was added to 1 liter of room temperature water and stirred until dissolved. Then, 250 grams of [bis[2-[bis(phosphonomethyl)amino]ethyl]amino]methylphosphonic acid (LFS 312, supplied by LFS chemical) was added to the solution. The resultant gelatinous precipitate was filtered and washed with water until the filtrate was neutral to litmus paper. The washed and filtered gelatinous precipitate was dried at 120° C. for 6 hours to produce free flowing powder of [bis[2-[bis(phosphonomethyl)amino]ethyl]amino]methylphosphonic acid tri aluminum salt.

Nuclear magnetic resonance spectroscopy, Fourier-transform infrared spectroscopy, and other analytical techniques were used to confirm the product structure was that of Compound V.

Example 11 (Inventive)—Controlled release testing. The release of active scale inhibitor (product of Example 10) at room temperature was measured using the above-described static release procedure. In this example, 2 grams of solids obtained from Example 10 were added to 100 g of distilled water. The sample was allowed to sit for 24 hours at room temperature (75° F.) or 160° F. The solid was filtered out of the fluid using a 45 μm filter. The solid was then transferred to a new container and 100 g of distilled water were added. The process was repeated and the fluid samples that were collected at specified time intervals were analyzed using ICP mass spectrometry. The residual phosphate released from the product at various time intervals is given below in Table 5. The static tests suggested the scale inhibitor continues to be released into fluid phase after 72 hours of exposure to water.

TABLE 5

| | Phosphate | Phosphate |
|---|---|---|
| Time | ion (ppm) | ion (ppm) |
| (hours) | (room temperature) | (160° F.) |
| 0 | 0 | 0 |
| 24 | 5,101 | 4,975 |
| 48 | 1,665 | 1,987 |
| 72 | 1,256 | 1,376 |

Example 12 (Inventive)—In situ formation of [bis[2-[bis(phosphonomethyl)amino]ethyl]amino]methylphosphonic acid metal salt. A solution of LFS 312 (50% active ingredient, 50% water) and a separate solution of aluminum sulfate were combined using a Y-junction tubing. Upon contact of the two solutions, the [bis[2-[bis(phosphonomethyl)amino]ethyl]amino]methylphosphonic acid metal salt precipitated and clogged the tubing.

Example 13 (Inventive)—In situ formation of [bis[2-[bis(phosphonomethyl)amino]ethyl]amino]methylphosphonic acid metal salt. A solution of 1 wt % LFS 312 (50% active ingredient, 50% water) and a separate solution of w 1 wt % aluminum sulfate were combined using a Y-junction tubing. Upon contact of the two solutions, the [bis[2-[bis(phosphonomethyl)amino]ethyl]amino]methylphosphonic acid metal salt precipitated, but unlike Example 12, no clogging of the tubing was observed.

Example 14 (Inventive)—In situ formation of [bis[2-[bis(phosphonomethyl)amino]ethyl]amino]methylphosphonic acid metal salt. A solution of LFS 312 (50% active ingredient, 50% water) and a separate solution of aluminum sulfate were simultaneously added dropwise to a beaker of stirring water at about 50 times dilution combined using a Y-junction tubing. Precipitation of the [bis[2-[bis(phosphonomethyl)amino]ethyl]amino]methylphosphonic acid metal salt was immediate.

Therefore, the present invention is well adapted to attain the ends and advantages mentioned as well as those that are inherent therein. The particular examples and configurations disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

1. A composition comprising: 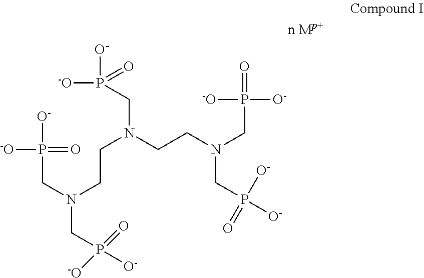
where M^{p+} is a metal cation having a p+ charge with p being 2, 3, or 4, and where n is an integer from 1 to 5.

2. The composition of claim 1, wherein the metal cation includes a metal selected from the group consisting of zinc, nickel, cadmium, manganese, aluminum, scandium, gallium, lanthanum, iron, cobalt, boron, silicon, tin, bismuth, titanium, vanadium, chromium, tungsten, and copper.

3. The composition of claim 1, further comprising a porous particle, a nonporous particle, or a mixture of the porous particle and the nonporous particle.

4. The composition of claim 1, wherein the Compound I is in a form of particulates.

5. A method comprising:
absorbing the composition of claim 1 into at least a portion of the pores of a porous particle.

6. A method comprising:
introducing a wellbore fluid into a wellbore penetrating a subterranean formation, wherein the wellbore fluid comprises the composition of claim 1.

7. A method comprising:
introducing the composition of claim 1 into a wellbore penetrating a subterranean formation; and
inhibiting scale in a portion of the wellbore and/or the subterranean formation.

8. A method comprising:
introducing the composition of claim 1 into a wellbore penetrating a subterranean formation, wherein the composition is in a form of particulates;
heating the particulates to a temperature of 150° F. or greater while in the wellbore and/or in the subterranean formation so as to release the Compound I from the particulates; and
inhibiting scale in a portion of the wellbore and/or the subterranean formation.

9. The composition of claim 1, further comprising:
a porous particle; wherein
one or more of Compound I is absorbed in pores of the porous particle.

10. A method comprising:
mixing a metal salt in water with [bis[2-[bis(phosphonomethyl)amino]ethyl]amino]methylphosphonic acid;
precipitating Compound I 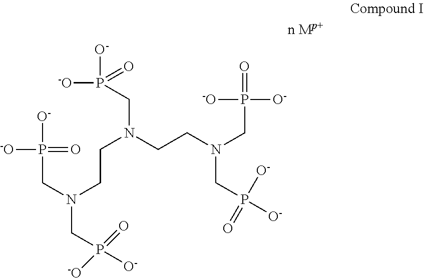
where M^{p+} is a metal cation having a p+ charge with p being an integer of 2, 3, or 4, and where n is an integer from 1 to 5; and
separating the Compound I from at least a portion of water.

11. The method of claim 10, wherein a molar ratio of [bis[2-[bis(phosphonomethyl)amino]ethyl]amino]methylphosphonic acid to a metal of the metal salt is 0.5:1 to 1:10.

12. The method of claim 10, wherein a metal cation of the metal salt includes a metal selected from the group consisting of zinc, nickel, cadmium, manganese, aluminum, scandium, gallium, lanthanum, iron, cobalt, boron, silicon, tin, bismuth, titanium, vanadium, chromium, tungsten, and copper.

13. The method of claim 10, wherein the Compound I after the separating is in a form of particulates.

14. The method of claim 10 further comprising:
introducing the Compound I into a wellbore penetrating a subterranean formation.

15. The method of claim 10 further comprising:
introducing the Compound I into a wellbore penetrating a subterranean formation; and
inhibiting scale in a portion of the wellbore and/or the subterranean formation.

16. The method of claim 10, wherein the Compound I after the separating is in a form of particulates, the method further comprising:
introducing the particulates into a wellbore penetrating a subterranean formation;
heating the particulates to a temperature of 150° F. or greater while in the wellbore and/or in the subterranean formation so as to release the Compound I from the particulates; and
inhibiting scale in a portion of the wellbore and/or the subterranean formation.

17. A method comprising:
mixing, at a wellsite, a metal salt in water with [bis[2-[bis(phosphonomethyl)amino]ethyl]amino]methylphosphonic acid;
precipitating Compound I 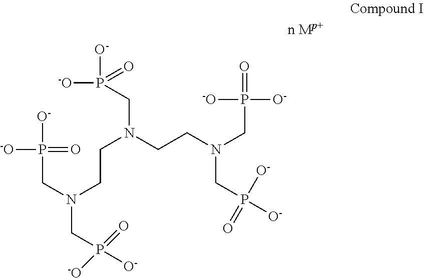
where M^{p+} is a metal cation having a p+ charge with p being an integer of 2, 3, or 4, and where n is an integer from 1 to 5; and
introducing the Compound I into a wellbore penetrating a subterranean formation.

18. The method of claim 17, wherein the mixing includes in-line mixing of the metal salt in water and the [bis[2-[bis(phosphonomethyl)amino]ethyl]amino]methylphosphonic acid.

19. The method of claim 17, wherein the mixing includes adding the metal salt in water and the [bis[2-[bis(phosphonomethyl)amino]ethyl]amino]methylphosphonic acid separately to a fluid comprising water.

20. The method of claim 17, wherein the Compound I is in a form of particulates when introduced into the wellbore.
